(19) United States
(12) Patent Application Publication
(10) Pub. No.: US 2026/0295312 A1
(43) Pub. Date: Oct. 1, 2026

(54) FALL PREVENTION SAFETY DEVICE

(71) Applicant: NEUTES INC., Cheongju-si, Chungcheongbuk-do (KR)

(72) Inventors: Hu-Shik KIM, Sejong-si (KR); Dae-Ho LEE, Daejeon (KR)

(73) Assignee: NEUTES INC., Cheongju-si, Chungcheongbuk-do (KR)

(21) Appl. No.: 19/480,432

(22) PCT Filed: Apr. 26, 2024
(86) PCT No.: PCT/KR2024/005728

§ 371 Date: Oct. 31, 2025

(30) Foreign Application Priority Data
May 8, 2023 (KR) 10-2023-0059485

(51) Int. Cl. A62B 35/00

(52) U.S. Cl. CPC A62B 35/0081

(57) ABSTRACT

A fall prevention safety device according to an embodiment of the present invention is firmly fixed and fastened to a wire to better prevent falling accidents of a worker, and can be easily attached to or detached from the wire in a work environment to improve work efficiency and prevent safety accidents during operation. The fall prevention safety device according to an embodiment of the present invention may comprise: a main body installed on a wire, including a first frame positioned on one side of the wire and a second frame connected to the first frame and configured to surround one surface of the wire; a clamping unit connected to the first frame and positioned on one side of the wire, the clamping unit being movable toward the wire; and an actuating unit connected to the first frame and configured to press the clamping unit toward the wire.

### TECHNICAL FIELD

The present invention relates to a fall prevention safety device that can be used to ensure the safety of a worker. More particularly, the invention pertains to a fall prevention safety device configured to prevent a worker from falling while ascending or descending along a vertical lifeline during work performed at an elevated location.

### BACKGROUND

Various types of safety devices have been used at construction sites and industrial workplaces to prevent safety accidents involving workers. In particular, when performing work at an elevated position, a worker is required to wear a specific device to prevent falling during such high-altitude work. According to Safety Regulation Article 371, performing work at a high place involves a significant risk of injury and may easily lead to fatal accidents, and therefore, the use of a safety device that prevents falling is one of the essential requirements that must be observed at the worksite.

As an example of a device for preventing falls, a fixed device may be installed at a specific point within a work area, and a flexible wire may be connected to the fixed device. Through the wire, the worker can move freely up and down within the work area. When a fall occurs during the work, a safety device connected to the worker's body is engaged and secured to the wire so as to prevent the worker from falling further.

For example, a clamping structure that tightens and secures a wire arranged along the work area may be used when a worker falls. However, in such safety devices employing a clamping mechanism, problems may occur in that the clamping force of the device is insufficient, causing the worker to fall, or the safety device may detach from the wire, requiring the worker to recheck or reinstall the device during work.

Accordingly, there is a need for a safety device that can firmly hold a worker with stronger clamping force in the event of a fall, and that allows the worker to easily engage or disengage the safety device with a wire or other surrounding structure at the worksite.

In connection with the above, Korean Patent Publication No. 10-2022-0112148 discloses a fall-arrest belt coupled with a hook. The disclosed invention relates to a hook for high-altitude work and a fall-arrest belt worn by a worker at construction sites or industrial workplaces to ensure safety during work performed at elevated locations.

### DISCLOSURE OF INVENTION

### Technical Problem

An object of the present invention is to provide a fall prevention safety device that is more firmly fixed to a wire when a worker falls.

Another object of the present invention is to provide a fall prevention safety device that allows a worker to easily engage or disengage the device with a wire in a work environment.

A further object of the present invention is to provide a fall prevention safety device in which one side of a frame surrounding the wire is open, so that when the wire is coupled to a specific structure such as a transmission tower, a middle support portion serving as the coupling section can smoothly pass through the frame without interference.

### Solution to the Problem

According to an embodiment of the present invention, a fall prevention safety device comprises: a main body installed on a wire, the main body including a first frame positioned on one side of the wire and a second frame connected to the first frame and configured to surround one surface of the wire; a clamping unit connected to the first frame and positioned on one side of the wire, the clamping unit being movable toward the wire; an actuating unit connected to the first frame and configured to press the clamping unit toward the wire; and an engaging unit configured to support one side of the clamping unit so that the wire is positioned between the second frame and the clamping unit, or to move the clamping unit outward away from the wire.

The first frame may include a clamping hole formed therethrough, and a portion of the clamping unit may pass through the clamping hole so that the clamping unit is movable along the clamping hole.

The clamping unit may include a clamping body positioned on one side of the wire and movable toward the wire, and a clamping pin protruding from the clamping body and passing through the clamping hole.

The actuating unit may be configured to push the clamping pin so as to move the clamping unit along the clamping hole.

The engaging unit may support one surface of the clamping pin to maintain a distance between the second frame and the clamping body.

The actuating unit may include an actuating body that rotates about a portion connected to the first frame as a rotational axis.

The actuating body may include an actuating groove recessed to receive a portion of the clamping unit, and the actuating body may press a portion of the clamping unit through the actuating groove.

The first frame may include a clamping hole formed therethrough, and the clamping unit may include a clamping body positioned on one side of the wire and movable toward the wire, and a clamping pin protruding from the clamping body and passing through the clamping hole, wherein the clamping unit may be pressed toward the wire by the clamping pin inserted into the actuating groove.

The actuating unit may further include a rotational elastic member positioned at a portion where the actuating body and the first frame are connected, the rotational elastic member being configured to rotate the actuating body.

The rotational elastic member may rotate the actuating body through elastic deformation.

The actuating body may be rotatable in a direction in which it is inserted toward an inner side of the first frame.

The first frame may include a clamping hole formed therethrough in parallel with a rotational path of the actuating body.

The first frame may include an engaging hole formed therethrough, and a portion of the engaging unit may pass through the engaging hole such that the engaging unit is movable along the engaging hole.

The first frame may include a first clamping hole formed therethrough along a movement path of the actuating unit, and a second clamping hole formed therethrough in parallel with the first clamping hole.

The clamping unit may include a clamping body positioned on one side of the wire and movable toward the wire, a first clamping pin protruding from the clamping body and passing through the first clamping hole, and a second clamping pin protruding from the clamping body and passing through the second clamping hole.

The engaging unit may include a first engaging unit contacting the first clamping pin, and a second engaging unit contacting the second clamping pin.

The engaging hole may include a first engaging hole through which a portion of the first engaging unit passes, and a second engaging hole through which a portion of the second engaging unit passes.

The first engaging unit may include a first support surface that supports the first clamping pin, a first engaging body positioned outside the first frame, and a first engaging pin protruding from the first engaging body and passing through the first engaging hole.

The first engaging unit may further include a compressive elastic member having one side fixed to the first frame and the other side connected to the first engaging pin, the compressive elastic member being elastically deformable.

As the first engaging pin moves along the first engaging hole by the elastic force of the compressive elastic member, the first support surface may be released from the first clamping pin.

The first engaging hole may include a portion formed through along a longitudinal direction of the wire and a portion formed through along a direction in which the compressive elastic member is elastically deformed.

The first engaging body may further include a pressing surface configured to press the first clamping pin when the first engaging pin moves along the first engaging hole.

The second engaging unit may include a second support surface configured to support the second clamping pin, a second engaging body positioned outside the first frame, and a second engaging pin protruding from the second engaging body and passing through the second engaging hole.

The second engaging unit may further include a tensile elastic member having one side fixed to the first frame and the other side connected to the second engaging pin, the tensile elastic member being elastically deformable.

As the second engaging pin moves along the second engaging hole in a direction opposite to a force applied by the tensile elastic member, the second support surface may be released from the second clamping pin.

The second engaging hole may be formed through along a longitudinal direction of the wire, and the tensile elastic member may be positioned inside the second engaging hole along the longitudinal direction of the wire.

### Effects of the Invention

According to a preferred embodiment of the present invention, the fall prevention safety device can be more firmly fixed to the wire, thereby more effectively preventing the worker from falling.

According to a preferred embodiment of the present invention, the fall prevention safety device can be more easily engaged with or disengaged from a wire in a work environment, thereby improving work efficiency and preventing potential safety accidents that may occur during operation.

According to another preferred embodiment of the present invention, since one side of the frame surrounding the wire is open, the wire can smoothly pass through a middle support portion, which is a coupling section connected to a specific structure such as a transmission tower, without interference.

In addition to the effects described above, other predictable advantages may be obtained by those skilled in the art from the configurations of the preferred embodiments of the present invention.

### BRIEF DESCRIPTION OF DRAWINGS

The accompanying drawings illustrate preferred embodiments of the present invention and, together with the following detailed description, serve to further understand the technical concept of the invention. However, the present invention should not be limited to the matters described in the drawings.

FIG. 1 is a perspective view showing a fall prevention safety device moving along a wire according to an embodiment of the present invention.

FIG. 2 is an internal cross-sectional view showing the fall prevention safety device moving along the wire according to an embodiment of the present invention.

FIG. 3 is a perspective view showing the fall prevention safety device in an actuated state according to an embodiment of the present invention.

FIG. 4 is an internal cross-sectional view showing the fall prevention safety device in an actuated state according to an embodiment of the present invention.

FIG. 5 is an internal cross-sectional view showing the fall prevention safety device being disengaged from the wire according to an embodiment of the present invention.

FIG. 6 is an internal cross-sectional view showing the fall prevention safety device being engaged with the wire in the reverse direction according to an embodiment of the present invention.

### DETAILED DESCRIPTION

Hereinafter, exemplary embodiments of the present invention will be described in detail with reference to the accompanying drawings. In assigning reference numerals to the components of the drawings, the same reference numerals are used for the same components as far as possible, even when such components appear in different drawings. In addition, in describing the embodiments, detailed descriptions of well-known structures or functions are omitted when they may unnecessarily obscure the understanding of the embodiments of the present invention.

In describing the components of the embodiments, terms such as first, second, A, B, (a), and (b) may be used merely to distinguish one component from another, and such terms do not limit the nature, order, or sequence of the components. When it is stated that one component is “connected,” “coupled,” or “linked” to another component, the components may be directly connected or coupled, or they may be indirectly connected or coupled via other components.

Components having common functions in one embodiment and in another embodiment may be described using the same reference numerals and terminology. Unless otherwise specified, the descriptions of one embodiment may equally apply to other embodiments, and redundant explanations will be omitted where appropriate.

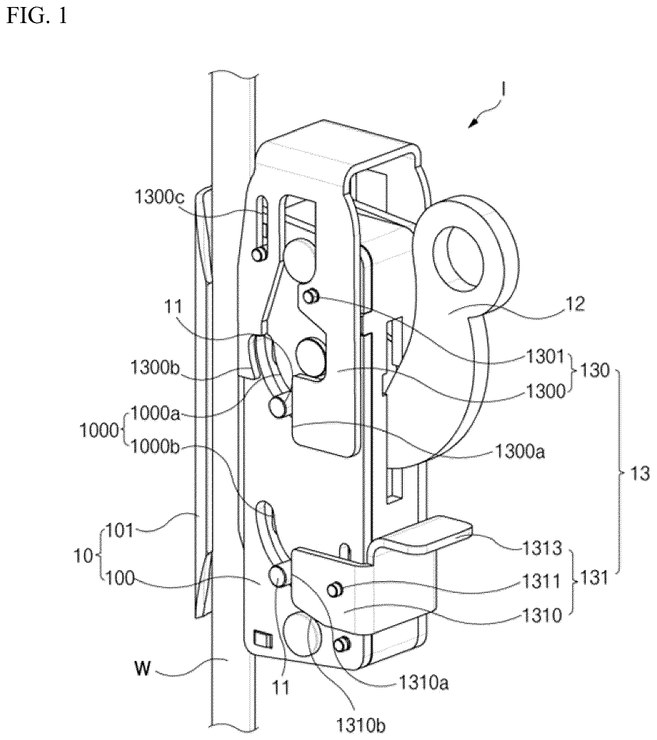

FIG. 1 is a perspective view showing a fall prevention safety device (1) moving along a wire (W) according to an embodiment of the present invention.

Referring to FIG. 1, the fall prevention safety device (1) according to an embodiment of the present invention is configured to prevent a worker from falling. For example, the fall prevention safety device (1) may be installed on a wire (W) or another surrounding structure in a work environment and connected to the worker, such that the device is activated when the worker falls.

Specifically, the worker may freely move within the work area while the fall prevention safety device (1) is installed on the wire (W). When an external force is applied to the device due to the worker's fall, the device is actuated and fixed to the wire (W), thereby suspending the worker in the air and preventing a fall.

The fall prevention safety device (1) may be fixed to the wire (W) through a clamping structure, that is, a tightening mechanism. For example, when operation is triggered by the worker's fall, the fall prevention safety device (1) clamps and grips the wire (W) through a wedge-type action, thereby securing itself to the wire.

In addition, the fall prevention safety device (1) may be easily engaged with or disengaged from the wire (W) according to the worker's convenience or the working environment. For instance, the device may include a handleable and elastically deformable structure, allowing the worker to attach or detach the device from the wire with ease.

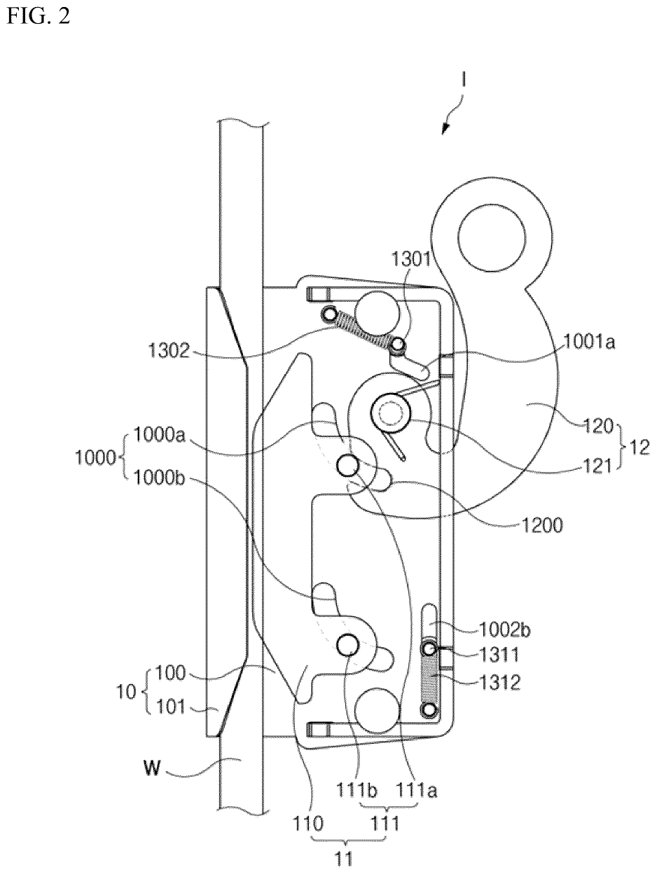

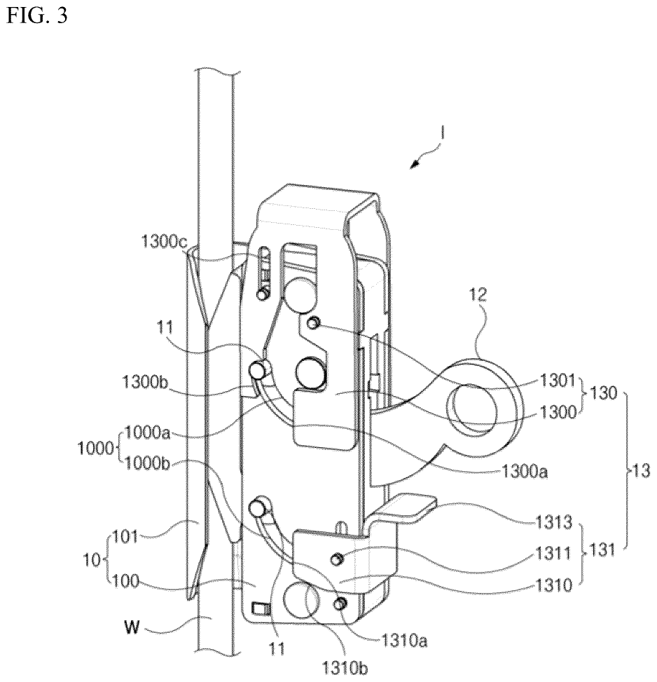

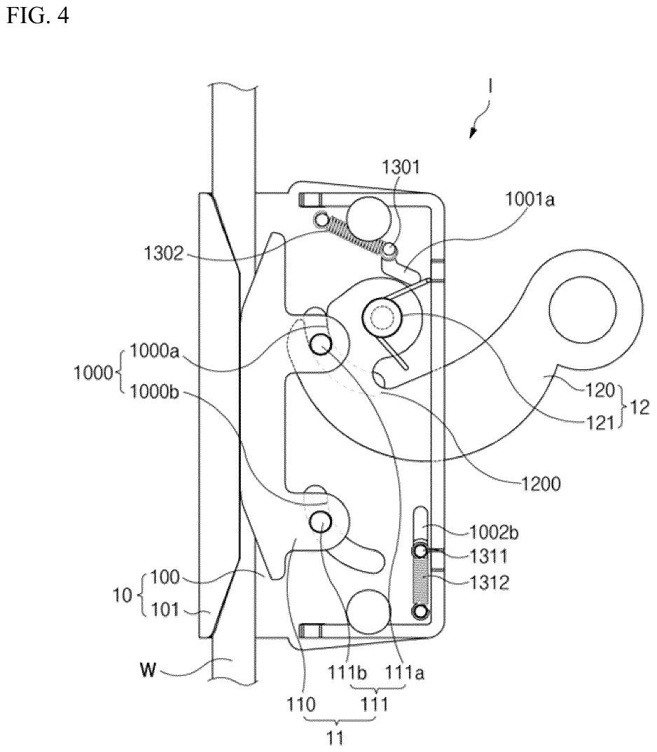

FIG. 2 is an internal cross-sectional view showing the fall prevention safety device (1) moving along the wire (W) according to an embodiment of the invention. FIG. 3 is a perspective view showing the fall prevention safety device (1) in an actuated state, and FIG. 4 is an internal cross-sectional view of the same actuated state.

Referring to FIGS. 2 to 4, the fall prevention safety device (1) may include a main body (10), a clamping unit (11), an actuating unit (12), and an engaging unit (13).

The main body (10) may form the outer appearance of the fall prevention safety device (1) and may be installed on the wire (W). For example, a portion of the main body (10) may be fastened around the wire (W). In addition, the main body (10) may provide a frame that allows the other components of the fall prevention safety device (1) to operate in an integrated manner.

Specifically, the main body (10) may include a first frame (100) and a second frame (101).

The first frame (100) may be positioned on one side of the wire (W), and the second frame (101) may be connected to the first frame (100) and configured to surround one surface of the wire (W). In other words, while the second frame (101) surrounds one side of the wire (W), the first frame (100) may be spaced apart from the wire.

The second frame (101) may be formed along the longitudinal direction of the wire (W) so as to partially surround the wire. Since the second frame (101) surrounds only one lateral side of the wire (W), a non-surrounded region may remain on the opposite side.

Through this non-surrounded region, the wire (W) may be engaged or disengaged with the device. Alternatively, when the worker is suspended from the wire, a middle support structure may pass through the open region without interference.

The middle support structure may refer to a connecting portion that links the wire (W) to a specific structure, such as a transmission tower. However, the term is not limited thereto and may encompass any structure located along the path of the fall prevention safety device (1) that may interfere with its movement.

In conventional fall arrest systems, when a safety device is connected to a wire, the worker must detach the device from the wire to pass a middle support structure, and then reattach it on the opposite side, which is inconvenient. Although pass-through type safety devices have been proposed to address this issue, such conventional devices still lack sufficient clearance for the middle support structure to pass smoothly, causing frequent interference or snagging.

In the present invention, a space may be formed between the first frame (100) and the second frame (101), allowing the wire (W) or the middle support structure to pass through. According to this structure, and as described in connection with the clamping unit (11) below, the main body (10) may be attached to or detached from the wire (W).

Accordingly, when the main body (10) moves upward or downward along the middle support structure, it can pass smoothly without interference, without being detached from the wire (W).

The clamping unit (11) may be connected to the first frame (100) and movable toward the wire (W). For example, the clamping unit (11) may be connected to the first frame (100) so as to be positioned on one side of the wire (W). Specifically, the first frame (100) may include a clamping hole (1000) formed therethrough, and a portion of the clamping unit (11) may pass through the clamping hole (1000) such that the clamping unit (11) is movable along the clamping hole (1000).

In other words, the clamping unit (11) may be positioned inside the first frame (100) with a portion protruding outward through the clamping hole (1000), and it may move along the path defined by the clamping hole (1000) while remaining inserted and fastened therein.

More specifically, the second frame (101) and the clamping unit (11) may be disposed on opposite sides of the wire (W). That is, while the second frame (101) surrounds one surface of the wire (W), the clamping unit (11) may approach or separate from the opposite surface of the wire (W). Accordingly, through the clamping structure formed by the second frame (101) and the clamping unit (11), the fall prevention safety device (1) may be secured to the wire (W).

The clamping unit (11) may include a clamping body (110) and clamping pins (111).

The clamping body (110) may be positioned on one side of the wire (W) and movable toward the wire. For example, the clamping body (110) may be located inside the first frame (100) and extend along the wire (W). The clamping body (110), together with the second frame (101), may clamp the wire (W)—thus constituting a clamping structure.

Specifically, the clamping body (110) may include a concave portion that grips the wire (W). A surface of the clamping body (110) that contacts the wire (W) may include a wedge-shaped portion, and when the fall prevention safety device (1) is actuated, the wedge action of the clamping body (110) causes it to tightly press the wire (W), thereby fixing the device to the wire.

The clamping pin (111) may protrude from the clamping body (110) and pass through the clamping hole (1000). For example, the clamping pin (111) may protrude perpendicularly from one surface of the clamping body (110), such that it extends outward of the first frame (100). The protruding direction of the clamping pin (111) may be perpendicular to the longitudinal direction of the wire (W), which corresponds to the movement direction of the fall prevention safety device (1).

Specifically, the clamping body (110) may include a portion extending outward from the wire (W), and the clamping pin (111) may be protrudingly formed on the extended portion of the clamping body (110).

In addition, the clamping hole (1000) may be formed on both sides of the first frame (100). The clamping pins (111) may protrude from both sides of the clamping body (110) and pass through the clamping holes (1000), thereby extending outward from both lateral sides of the first frame (100).

Multiple clamping holes (1000) may be provided. For example, a plurality of clamping holes (1000) may be formed on one surface of the first frame (100). According to an embodiment of the present invention, providing at least one clamping hole (1000) increases the clamping force applied by the clamping unit (11) to the wire (W), thereby enhancing the braking performance and ensuring uniform contact between the upper and lower portions of the clamping unit (11) and the wire (W).

In one embodiment, the clamping hole (1000) may include a first clamping hole (1000a) and a second clamping hole (1000b), which may be formed on the same plane.

The first clamping hole (1000a) may be formed along a movement path of the actuating unit (12) on the outer surface of the first frame (100), and the second clamping hole (1000b) may be formed parallel to the first clamping hole (1000a) on the same outer surface. That is, the shape of the second clamping hole (1000b) may be identical to that of the first clamping hole (1000a), and the first clamping hole (1000a) may be positioned above the second clamping hole (1000b).

The clamping pin (111) may include a first clamping pin (111a) protruding from the clamping body (110) and passing through the first clamping hole (1000a), and a second clamping pin (111b) protruding from the clamping body (110) and passing through the second clamping hole (1000b).

The first clamping pin (111a) and second clamping pin (111b) may respectively extend through the first clamping hole (1000a) and second clamping hole (1000b), and may be movable along the respective holes. Accordingly, the clamping unit (11) may move toward or away from the wire (W).

Detailed descriptions of the functions and operations of the first and second clamping pins will be provided later in connection with the actuating unit (12) and the engaging unit (13).

The actuating unit (12) may be configured to press the clamping unit (11) so that the clamping unit (11) tightly contacts the wire (W). For example, the actuating unit (12) may be connected to the worker, and when a fall accident occurs, the actuating unit (12) may move in a predetermined direction to operate. As the actuating unit (12) moves, it may push the clamping unit (11) positioned along its movement path, thereby moving the clamping unit (11) in accordance with the movement of the actuating unit (12).

Specifically, the actuating unit (12) may rotate about a rotation shaft, and as it rotates, it pushes the clamping unit (11) located along its rotational path, thereby moving the clamping unit (11) along the path of rotation. That is, the actuating unit (12) may push the clamping pin (111) to move the clamping unit (11) along the clamping hole (1000) formed in the first frame (100).

The actuating unit (12) may include an actuating body (120) and a rotational elastic member (121).

The actuating body (120) may be connected to the first frame (100) and rotatable about a portion connected to the first frame (100). For example, the actuating body (120) may be rotatable in a direction toward the inner side of the first frame (100).

More specifically, one side of the actuating body (120) may be connected to the inner side of the first frame (100), and the other side may protrude outward from the first frame (100). When the worker, who is connected to the outer side of the actuating body (120), falls, the actuating body (120) rotates about its connected portion as a rotation axis. In this case, the outer protruding portion of the actuating body (120) rotates inward toward the inner side of the first frame (100) along its rotation radius.

A ring-shaped structure may be formed at the outer end of the actuating body (120) to connect the wire (W) or a rope linked to the worker.

The actuating body (120) may include an actuating groove (1200) recessed to receive a portion of the clamping unit (11). That is, the actuating groove (1200) may have a shape corresponding to the clamping pin (111) and may surround it. Through this actuating groove (1200), the actuating body (120) may press a portion of the clamping unit (11). In other words, the clamping unit (11) may be pressed toward the wire (W) by the clamping pin (111) inserted into the actuating groove (1200). In particular, the first clamping pin (111a) may be inserted into the actuating groove (1200).

According to the structure of the actuating groove (1200), the external force generated by the rotation of the actuating unit (12) may be more effectively applied to the first clamping pin (111a), thereby enhancing the fall-prevention performance of the device.

The clamping hole (1000) may be formed along the rotational path of the actuating unit (12). For example, the first clamping hole (1000a) may be formed along the rotation radius of the actuating unit (12). Thus, as the actuating unit (12) rotates inward into the first frame (100), it may press the first clamping pin (111a).

The first clamping pin (111a) may be pushed upward by the actuating unit (12). For example, the actuating unit (12) may move the first clamping pin (111a) upward and toward the wire (W).

Additionally, the second clamping hole (1000b) may be formed parallel to the rotation radius of the actuating unit (12).

As a result, when a fall accident occurs, the outer side of the actuating body (120) receives an external force from the worker, causing the actuating body (120) to rotate. The first clamping pin (111a) inserted into the actuating groove (1200) is thereby pushed, and the clamping body (110) connected to the first clamping pin (111a) moves toward the wire (W) and presses against the wire, thereby securing the safety device (1) to the wire (W) by a wedge action.

The rotational elastic member (121) may be configured to rotate the actuating body (120). For example, the rotational elastic member (121) may be positioned at the connection portion between the actuating body (120) and the first frame (100), that is, on the rotation axis.

The rotational elastic member (121) may rotate the actuating body (120) in the same direction as the rotation direction in which the clamping unit (11) approaches the wire (W).

The rotational elastic member (121) may rotate the actuating body (120) through elastic deformation. For example, the rotational elastic member (121) may include a torsion spring. When the safety device (1) moves freely along the wire (W) without being fixed, the actuating body (120) may rotate in a direction opposite to the direction of the elastic force of the torsion spring.

More specifically, when the actuating unit (12) is connected to the worker through a rope, gravity causes the remaining components to move downward, while the actuating unit (12) is in a rotated upward position. In this case, the rotational elastic member (121) applies a counter-rotational force in the opposite direction to the rotated position of the actuating unit (12).

When the worker falls and the actuating body (120) rotates to push the clamping pin (111), the torsion spring further rotates the actuating body (120) in the same direction as its rotation, thereby allowing the safety device (1) to be activated explosively in response to the fall.

Consequently, when the safety device (1) is fixed to the wire (W) during a fall, even a small motion of the actuating unit (12) can trigger and accelerate rotation, thereby enhancing the fall-prevention function of the fall prevention safety device (1).

In the embodiment of the present invention, the rotational elastic member (121) corresponding to the rotation axis of the actuating body (120) and the first clamping pin (111a) corresponding to the movement axis of the clamping body (110) may be mechanically separated. This separated configuration can be explained in terms of a lever mechanism.

Specifically, when a rope connected to the worker pulls the ring of the actuating body (120) upward or downward, the ring acts as a point of force, the rotational elastic member (121) acts as a fulcrum, and the first clamping pin (111a) acts as a point of action in the lever system.

The moment is defined as the product of the distance from the fulcrum and the force acting perpendicularly at that point. When the moments at the point of force and the point of action are equal, the lever is in equilibrium. Therefore, by shortening the distance between the point of action and the fulcrum, a greater force can be applied at the point of action than the force applied at the point of force.

Utilizing this lever principle, even when a small force is applied to the actuating body (120) by the worker during normal movement along the wire (W), a greater force than the tension of the rotational elastic member (121) can be applied to pull the actuating body (120) upward. Accordingly, the clamping unit (11) may be separated from the wire (W) as needed.

Conversely, during a fall of the worker, the clamping force of the clamping unit (11) on the wire (W) may be maximized relative to the downward pulling force applied by the wire on the actuating body (120), thereby enabling effective braking.

The engaging unit (13) may be configured to control engagement of the fall prevention safety device (1) with the wire (W). For example, by adjusting the distance between the wire (W) and the clamping unit (11) through its movement, the engaging unit (13) may engage or release the fall prevention safety device (1) from the wire (W).

The engaging unit (13) may support one side of the clamping unit (11) such that the wire (W) is positioned between the second frame (101) and the clamping unit (11). For example, the engaging unit (13) may support a surface of the clamping pin (111) to maintain a distance between the second frame (101) and the clamping body (110). That is, in a direction perpendicular to the longitudinal direction of the wire (W), the engaging unit (13) may function to prevent the wire (W) from escaping the space between the second frame (101) and the clamping unit (11).

Conversely, the engaging unit (13) may function to move the clamping unit (11) outward, thereby allowing the wire (W) to be released from between the second frame (101) and the clamping unit (11). In other words, by retracting the supporting structure of the clamping unit (11) or by pressing the clamping unit (11) in a direction opposite to its fastening direction, the fall prevention safety device (1) may be disengaged from the wire (W).

The first frame (100) may further include an engaging hole (1001) formed therethrough. A portion of the engaging unit (13) may pass through the engaging hole (1001) so that the engaging unit (13) is movable along the engaging hole (1001). The engaging hole (1001) may include a first engaging hole (1001a) formed at an upper portion of the first frame (100) and a second engaging hole (1001b) formed at a lower portion of the first frame (100).

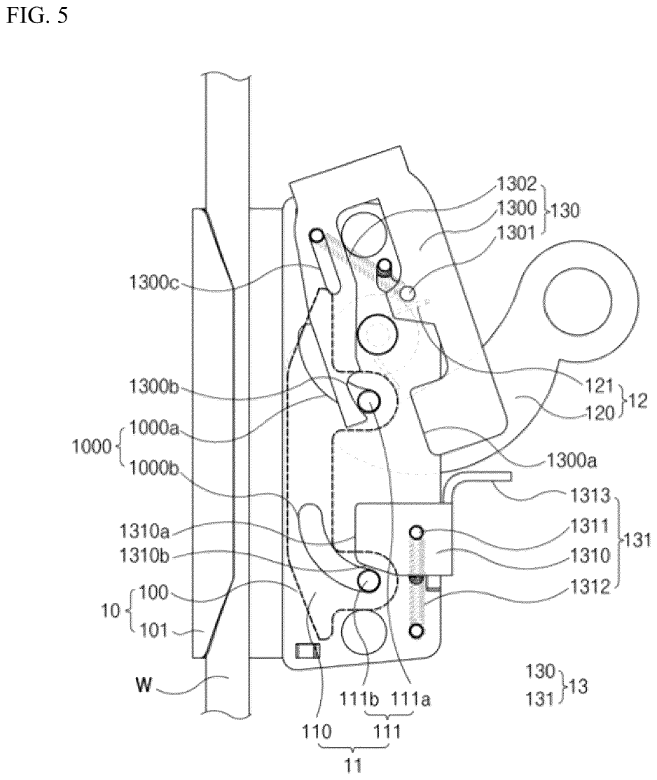

FIG. 5 is an internal cross-sectional view showing the fall prevention safety device (1) being disengaged from the wire (W) according to an embodiment of the present invention.

Referring to FIG. 5, the engaging unit (13) may include a first engaging unit (130) and a second engaging unit (131).

The first engaging unit (130) may contact the first clamping pin (111a). For example, the first engaging unit (130) may support the first clamping pin (111a), or alternatively press the first clamping pin (111a) to move it in a predetermined direction.

To operate the first engaging unit (130), a portion thereof may pass through the first engaging hole (1001a). The first engaging unit (130) may be movable over a predetermined distance. For example, the first engaging unit (130) may move downward, that is, toward the second engaging unit (131).

The first engaging unit (130) may include a first engaging body (1300) and a first engaging pin (1301).

The first engaging body (1300) may be positioned outside the first frame (100). For example, the first engaging body (1300) may have a shape that partially surrounds an upper portion of the first frame (100). That is, with reference to the longitudinal direction of the wire (W), the first engaging body (1300) may extend along both lateral sides of the first frame (100).

The first engaging pin (1301) may protrude from the first engaging body (1300) and pass through the first engaging hole (1001a). For example, when the first engaging body (1300) is formed on both sides of the first frame (100), the first engaging pin (1301) may sequentially pass through the first engaging body (1300), the first frame (100), and the opposite first engaging body (1300).

The first engaging pin (1301) may move along the first engaging hole (1001a), and accordingly, the first engaging unit (130) may be movable over a predetermined distance.

The first engaging body (1300) may include a first support surface (1300a) configured to support the first clamping pin (111a). By releasing the supporting state of the first support surface (1300a) with respect to the first clamping pin (111a), the clamping unit (11) may be released from the wire (W).

For example, the first support surface (1300a) may be formed below the first engaging hole (1001a), and the first engaging hole (1001a) may be oriented vertically. When the first engaging unit (130) is pressed downward by the worker (that is, toward the second engaging unit (131)), the first engaging unit (130) moves downward along the first engaging hole (1001a), and the first support surface (1300a) that previously supported the first clamping pin (111a) is released from contact, allowing the first clamping pin (111a) to be spaced apart.

More specifically, the first engaging unit (130) may further include a compression elastic member (1302) having one end fixed to the first frame (100) and the other end connected to the first engaging pin (1301). For example, the compression elastic member (1302) may include a compression spring capable of elastic deformation.

As the first engaging pin (1301) moves along the first engaging hole (1001a) by the elastic force of the compression elastic member (1302), the first support surface (1300a) may be separated from the first clamping pin (111a). In this case, the first engaging hole (1001a) may include a portion formed along the longitudinal direction of the wire (W) and another portion formed along the compression direction of the compression elastic member (1302).

That is, when the compression elastic member (1302) is compressed, that is, when the fall prevention safety device (1) is engaged with the wire (W), the opposite end of the compression elastic member (1302) may be positioned above the first engaging pin (1301) within the first engaging hole (1001a). When the worker presses the first engaging unit (130) downward from above to release engagement, the first engaging pin (1301) moves downward along the longitudinal direction of the wire (W), and thereafter, by the restoring force of the compression spring, the first engaging pin (1301) may move along the direction of elastic deformation within the first engaging hole (1001a).

The first engaging body (1300) may include a pressing surface (1300b) configured to press the first clamping pin (111a) when the first engaging pin (1301) moves along the first engaging hole (1001a). For example, if one side of the first clamping pin (111a) is supported by the first support surface (1300a), the opposite side of the first clamping pin (111a) may be pressed by the pressing surface (1300b) of the first engaging body (1300). In other words, the first engaging body (1300) may include a portion extending downward from its upper surface toward the opposite surface of the first clamping pin (111a), and as the worker presses the first engaging unit (130) downward, the pressing surface (1300b) may apply pressure to the opposite surface of the first clamping pin (111a).

In this case, the first engaging body (1300) may include a movement groove (1300c) formed through the body. For example, the movement groove (1300c) may be formed in the portion extending downward from the upper surface of the first engaging body (1300) toward the opposite surface of the first clamping pin (111a). A fixing pin that connects and fixes the first engaging unit (130) to the first frame (100) may be positioned within the movement groove (1300c). As the first engaging unit (130) is pressed downward, the movement groove (1300c) may move downward relative to the fixing pin.

As a result, the first engaging pin (1301) moves downward and away from the wire (W) along the first engaging hole (1001a), and the first support surface (1300a), which is spaced apart above the first engaging pin (1301), is separated from the first clamping pin (111a). At the same time, the movement groove (1300c) moves downward relative to the fixing pin, allowing the first engaging unit (130) to rotate slightly along a predetermined radius, thereby releasing the support on one side of the first clamping pin (111a) and pressing the opposite side. Accordingly, the clamping unit (11) may be disengaged from the wire (W).

The second engaging unit (131) may contact the second clamping pin (111b). In other words, the second engaging unit (131) may support the second clamping pin (111b) and may also release that support as necessary. For example, the second engaging unit (131) may pass through the second engaging hole (1001b) and move along it, thereby supporting or releasing the second clamping pin (111b).

The second engaging unit (131) may include a second engaging body (1310), a second engaging pin (1311), a tension elastic member (1312), and an operating portion (1313).

The second engaging body (1310) may be positioned outside the first frame (100), specifically at a lower side thereof. In this configuration, the second engaging body (1310) may be movable vertically along the longitudinal direction of the wire (W).

The second engaging pin (1311) may protrude from the second engaging body (1310) and pass through the second engaging hole (1001b). For example, when the second engaging body (1310) is formed on both sides of the first frame (100), the second engaging pin (1311) may sequentially pass through the second engaging body (1310), the first frame (100), and the opposite second engaging body (1310).

The second engaging hole (1001b) may be formed vertically along the longitudinal direction of the wire (W), and the second engaging pin (1311) may move vertically along the engaging hole (1001b).

The second engaging body (1310) may include a second support surface (1310a) configured to support the second clamping pin (111b). When the second engaging body (1310) is moved upward by the worker along the longitudinal direction of the wire (W), the second support surface (1310a) may be spaced apart from the second clamping pin (111b), and the second clamping pin (111b) may move away from the wire (W) along the second clamping hole (1000b).

The tension elastic member (1312) may have one end fixed to the first frame (100) and the other end connected to the second engaging pin (1311), and may be elastically deformable. In other words, the tension elastic member (1312) may include a compression spring. As the second engaging pin (1311) moves along the second engaging hole (1001b) opposite to the direction of the elastic force of the tension elastic member (1312), the second support surface (1310a) may be separated from the second clamping pin (111b).

The tension elastic member (1312) may be positioned inside the second engaging hole (1001b) along the longitudinal direction of the wire (W).

That is, when the fall prevention safety device (1) is engaged with the wire (W), that is, when the second clamping pin (111b) is located at the lower side of the second engaging hole (1001b), the second support surface (1310a) may support one surface of the second clamping pin (111b).

When the second engaging body (1310) is moved upward by the worker and the second engaging pin (1311) is thereby moved upward, the second engaging pin (1311) may stretch and deform the tension elastic member (1312) in a direction opposite to its restoring force. In this state, the second clamping pin (111b) may be released from the second support surface (1310a) and move away from the wire (W) along the second clamping hole (1000b).

To ensure that the second clamping pin (111b) moves smoothly away from the wire (W) after separating from the second support surface (1310a), the second engaging body (1310) may include an inclined surface (1310b) formed below the second support surface. In other words, the inclined surface (1310b) may be inclined relative to the second support surface (1310a) and may be connected to the lower side thereof. As the second engaging body (1310) moves upward, the second clamping pin (111b) that was in contact with the second support surface (1310a) may slide along the inclined surface (1310b) and thus move away from the wire (W).

The operating portion (1313) may be formed on the outer surface of the second engaging body (1310) and may be a part manipulated by the worker. For example, the operating portion (1313) may protrude outward from the second engaging body (1310) in a direction away from the wire (W). By pressing the lower surface of the operating portion (1313), the worker can move the second engaging body (1310) upward, that is, toward the first engaging unit (130), thereby allowing the second engaging unit (131) to be more easily operated.

Consequently, with the above-described structures of the first engaging unit (130) and second engaging unit (131), the fall prevention safety device (1) can be easily attached to or detached from the wire (W).

The fall prevention safety device (1) according to an embodiment of the present invention may perform an anti-reverse engagement function to prevent the worker from mistakenly installing the device in an inverted orientation relative to the wire (W).

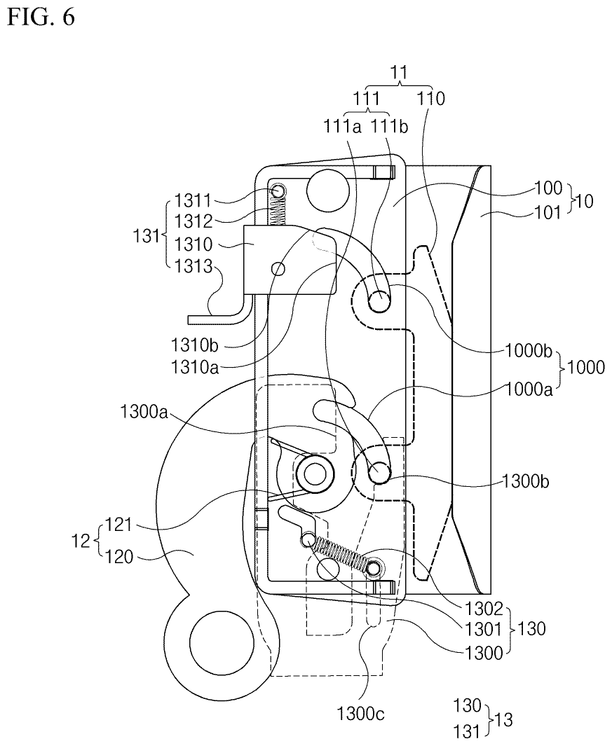

When the worker attempts to attach the fall prevention safety device (1) to the wire (W) in a reversed orientation, that is, upside-down relative to gravity, the device may not engage with the wire (W). In this regard, FIG. 6 is an internal cross-sectional view showing the fall prevention safety device (1) in an inverted engagement state with the wire (W).

Referring to FIG. 6, when the fall prevention safety device (1) is inverted relative to gravity, it may fail to engage with the wire (W). For example, in the inverted state, the clamping unit (11) may remain in close contact with the second frame (101).

In this inverted state, the clamping unit (11) may move downward along the clamping hole (1000) by gravity. As shown in FIG. 6, the clamping unit (11) may be positioned at the lower side of the clamping hole (1000) and contact the second frame (101).

Furthermore, the actuating unit (12) may only perform a pushing function on the clamping unit (11) and may not apply force to other components when rotated in the opposite direction. Accordingly, when the fall prevention safety device (1) is inverted and the actuating unit (12) rotates downward (that is, away from the clamping unit (11)), it may rotate independently without affecting other components.

Simultaneously, when the fall prevention safety device (1) is inverted and the worker operates the engaging unit (13) in an attempt to attach the device to the wire (W), the clamping unit (11) may remain in contact with the second frame (101).

Referring again to FIG. 6, when an upward external force is applied to the first engaging unit (130) by the worker, the first engaging pin (1301) also receives an upward force, and the pressing surface (1300b) may press the first clamping pin (111a) upward.

As illustrated in FIG. 6, viewed from the lower to the upper direction, the first engaging hole (1001a) may be formed along the longitudinal direction of the wire (W) and then extend diagonally away from the wire (W).

In contrast, the first clamping hole (1000a) may be formed as a partial circular arc corresponding to the rotational path of the actuating unit (12). In addition, the engaging unit (13) may be restricted to vertical movement only by the movement groove (1300c).

As a result, since the movement of the engaging unit (13) is restricted by the movement groove (1300c), and because the first engaging hole (1001a) and the first clamping hole (1000a) have different geometries, the engaging unit (13) may be prevented from moving by the first engaging pin (1301) and the first clamping pin (111a).

Accordingly, when the fall prevention safety device (1) is inverted, the worker cannot move the first engaging unit (130) upward, and the clamping unit (11) remains in contact with the second frame (101).

Additionally, even if the worker moves the second engaging unit (131) downward, the second engaging unit (131) may not affect other components; thus, the clamping unit (11) remains in close contact with the second frame (101).

In the embodiment of the present invention, when the fall prevention safety device (1) is attached in reverse, the clamping unit (11) remains in contact with the second frame (101), thereby preventing the wire (W) from being inserted into the frame. Accordingly, this provides the advantage of preventing incorrect usage of the fall prevention safety device (1) by the worker.

The foregoing description merely illustrates the technical spirit of the invention through exemplary embodiments. It will be apparent to those skilled in the art that various modifications and alterations can be made without departing from the essential features of the present invention.

Therefore, the embodiments disclosed herein are intended not to limit but to explain the technical concept of the invention, and the scope of the invention should not be construed as limited thereto.

The scope of protection of the present invention shall be interpreted based on the following claims, and all equivalent technical ideas within such scope shall be included in the rights of the present invention.

The best mode for carrying out the invention has been described in detail in the foregoing embodiments.

The present disclosure relates to a fall prevention safety device applicable to worker safety, and because it is practically applicable and repeatable, it has industrial applicability.

What is claimed is:

1. A fall prevention safety device comprising:
a main body installed on a wire, including a first frame positioned on one side of the wire and a second frame connected to the first frame and configured to surround one surface of the wire;
a clamping unit connected to the first frame and positioned on one side of the wire, the clamping unit being movable toward the wire;
an actuating unit connected to the first frame and configured to press the clamping unit toward the wire; and
an engaging unit configured to support one side portion of the clamping unit so that the wire is positioned between the second frame and the clamping unit, or to move the clamping unit outwardly away from the wire.

2. The fall prevention safety device according to claim 1,
wherein the first frame includes a clamping hole formed therethrough,
and a portion of the clamping unit extends through the clamping hole, such that the clamping unit is movable along the clamping hole.

3. The fall prevention safety device according to claim 2,
wherein the clamping unit includes:
a clamping body positioned on one side of the wire and movable toward the wire; and
a clamping pin protruding from the clamping body and passing through the clamping hole.

4. The fall prevention safety device according to claim 3,
wherein the actuating unit is configured to press against the clamping pin so as to move the clamping unit along the clamping hole.

5. The fall prevention safety device according to claim 3,
wherein the engaging unit is configured to support one surface of the clamping pin so as to maintain a distance between the second frame and the clamping body.

6. The fall prevention safety device according to claim 1,
wherein the actuating unit includes an actuating body configured to rotate about a portion connected to the first frame,
and the actuating body is rotatable in a direction in which it is inserted into an inner side of the first frame.

7. The fall prevention safety device according to claim 6,
wherein the actuating body includes an actuating groove recessed to receive a portion of the clamping unit,
and the actuating body is configured to push a portion of the clamping unit through the actuating groove.

8. The fall prevention safety device according to claim 7,
wherein the first frame includes a clamping hole formed therethrough, the clamping unit includes a clamping body positioned on one side of the wire and movable toward the wire,
and a clamping pin protruding from the clamping body and passing through the clamping hole,
and the clamping unit is brought into close contact with the wire by the clamping pin inserted into the actuating groove.

9. The fall prevention safety device according to claim 6,
wherein the actuating unit further includes a rotational elastic member positioned at a portion where the actuating body is connected to the first frame, and the rotational elastic member is configured to rotate the actuating body through elastic deformation.

10. The fall prevention safety device according to claim 6,
wherein the first frame includes a clamping hole formed therethrough in parallel with a rotational path of the actuating body.

11. The fall prevention safety device according to claim 10,
wherein the first frame includes an engaging hole formed therethrough, and a portion of the engaging unit passes through the engaging hole, such that the engaging unit is movable along the engaging hole.

12. The fall prevention safety device according to claim 11,
wherein the first frame includes:
a first clamping hole formed therethrough along a movement path of the actuating unit; and
a second clamping hole formed therethrough in parallel with the first clamping hole.

13. The fall prevention safety device according to claim 12,
wherein the clamping unit includes:
a clamping body positioned on one side of the wire and movable toward the wire;
a first clamping pin protruding from the clamping body and passing through the first clamping hole; and
a second clamping pin protruding from the clamping body and passing through the second clamping hole.

14. The fall prevention safety device according to claim 13,
wherein the engaging unit includes:
a first engaging unit contacting the first clamping pin; and
a second engaging unit contacting the second clamping pin.

15. The fall prevention safety device according to claim 14,
wherein the engaging hole includes a first engaging hole through which a portion of the first engaging unit passes,
and a second engaging hole through which a portion of the second engaging unit passes.
